(19) United States
(12) Patent Application Publication
(10) Pub. No.: US 2019/0308898 A1
(43) Pub. Date: Oct. 10, 2019

(54) SEWAGE TREATMENT SYSTEM USING MULTISTAGE LONG-FIBER FILTERING DEVICE, AND TREATMENT METHOD THEREOF

(71) Applicants: ROPEN CO., LTD., Anyang-si, Gyeonggi-do (KR); GLOBAL ENFILTEC CO., LTD., Anyang-si, Gyeonggi-do (KR)

(72) Inventor: Choong Hyun CHOI, Suwon-si (KR)

(21) Appl. No.: 16/302,575

(22) PCT Filed: Apr. 26, 2017
(86) PCT No.: PCT/KR2017/004435

§ 371 Date: Nov. 16, 2018

(30) Foreign Application Priority Data
May 16, 2016 (KR) 10-2016-0059556

(51) Int. Cl. C02F 9/00; B01D 29/56; B01D 29/66

(52) U.S. Cl. CPC C02F 9/00; B01D 29/56; C02F 1/24; C02F 2303/16; B01D 29/66

(57) ABSTRACT

Provided are a sewage treatment system using a multistage long-fiber filtering device, and a treatment method thereof. The sewage treatment system uses at least one pressurized long-fiber filtering device and at least one submerged-type long-fiber filtering device to treat sewage by a direct filtration method. The pressurized long-fiber filtering device treats sewage by direct filtration, and the submerged-type long-fiber filtering device treats the sewage by concentrating backwashing water of filtered sewage and dehydrating and disposing of the backwashing water. The pressurized long-fiber filtering devices and the submerged-type long-fiber filtering devices are respectively provided in a modular including a plurality of the devices in a symmetrical structure to each other. Accordingly, as sewage is treated by direct filtration by using the pressurized long-fiber filtering device and the submerged-type long-fiber filtering device, greenhouse gases may be reduced without microbial treatment.

### TECHNICAL FIELD

The present disclosure relates to a sewage treatment system, and more particularly, to a sewage treatment system, in which at least one pressurized long-fiber filtering device and at least one submerged-type long-fiber filtering device are arranged in multiple stages, and sewage and backwashing water are treated by a direct filtration method by using the pressurized long-fiber filtering device and the submerged-type long-fiber filtering device, and a treatment method thereof.

### BACKGROUND ART

Domestic sewage refers to a state that organic and inorganic contaminants are dissolved and suspended in pure water, and the purification technique for sewage can be classified into a physical treatment method, a chemical treatment method, and a biological treatment method. One representative method of the physical treatment method is a filtration method, and examples of the chemical treatment method are a flocculation treatment method performed using a flocculent or an oxidation treatment method performed by using an oxidizing agent, and the biological treatment method is a treatment process performed by dissolving organic matters by growing microorganisms cultured in sewage itself and adsorbing inorganic matters. Most of the conventional sewage treatment processes are designed as a biological treatment process and operated, and are regarded as a most common sewage treatment process.

The most commonly used biological sewage treatment process consists of a reactor of an aerobic or anaerobic microbials, a solid-liquid separator such as a settling tank or submerged-type membranes, which are designed to dehydrate and discharge separated solids. Microbial reactors may have following operational problems due to several external factors.

First, a length of time of a biological reactor varies depending on a variation in an inflow flowrate of inflow sewage, differentiating treatment efficiencies. Second, a variation in the concentration of contaminants of inflowing sewage affects treatment efficiency, and in particular, problems are serious such that microorganisms become extinct due to an empty load at a very low contamination concentration. Third, a temperature change in sewage affects treatment efficiency, and the treatment efficiency decreases in winter. Fourth, during aeration in the bioreactor, serious odor is caused, and this needs to be covered and collected and treated in an additional treatment apparatus. Fifth, due to the long length of time in the microbial reactor, the construction area of the treatment plant is very large and the construction costs are high. Sixth, most biological sewage treatment processes except for very small-sized sewage treatment processes are constructed in the form of concrete tanks, and thus are impossible to move the treatment site, and constructing a treatment plant underground entails significantly higher construction costs. Seventh, carbon dioxide, NOX or the like generated in a microbial treatment process are those of the six global greenhouse gases, and the emission of these gases is to be prohibited or reduced according to the convention for reducing global greenhouse gases in the future.

Thus, many of problems occurring in a conventional microbial treatment process are due to the fact that organic and inorganic contaminants are not directly separated from sewage but decomposed using microorganisms, thus due to the growth conditions and decomposition mechanism of the microorganisms. To solve this, rather than performing a sewage treatment process by decomposition of contaminants by using microorganisms, a physical filtration process in which contaminants are directly separated from sewage is required.

### PRIOR ART DOCUMENTS

### Patent Document

(Patent Document 1) KR 10-0931987 (published on Dec. 15, 2009)

(Patent Document 2) KR 10-1424045 (published on Aug. 13, 2014)

(Patent Document 3) KR 10-1350537 (published on Jan. 13, 2014)

(Patent Document 4) KR 10-1450261 (published on Oct. 23, 2014)

### DETAILED DESCRIPTION OF EMBODIMENTS

### Technical Problem

The present disclosure provides a sewage treatment system in which multistage long-fiber filtering devices are used to treat sewage by a direct filtration method without microbial treatment, and a treatment method thereof.

The present disclosure also provides a sewage treatment system in which a plurality of pressurized long-fiber filtering devices are used to directly filter sewage, and backwashing water of the filtered sewage is concentrated by using a plurality of submerged-type long-fiber filtering devices to dehydrate and dispose of the same, and a treatment method thereof.

The present disclosure also provides a sewage treatment system in which a plurality of long-fiber filtering devices are used to minimize influence according to a variation in the flowrate, concentration, and temperature of sewage to thereby reduce greenhouse gases, and a treatment method thereof.

### Technical Solution

According to a sewage treatment system of the present disclosure for achieving the above-described objectives, at least one pressurized long-fiber filtering device and at least one submerged-type long-fiber filtering device are arranged in multistage, and backwashing water of filtered sewage is concentrated, dehydrated, and disposed of by using the pressurized long-fiber filtering device and the submerged-type long-fiber filtering device. A sewage treatment plant for the sewage treatment system according to the present disclosure as described above may be constructed in a very small and movable structure compared to a process that uses microorganisms, thus providing the effect of reducing greenhouse gases without microbial treatment and without being greatly affected by a change in the flow of inflow sewage or concentration or temperature change.

According to an aspect of the present disclosure, a sewage treatment system includes: a flowrate balancing tank receiving sewage flowing from the outside and storing the sewage; a scum remover removing floating contaminants from sewage supplied from the flowrate balancing tank; a sewage filtration treatment unit including at least one pressurized long-fiber filtering device, wherein the pressurized long-fiber filtering device receives, from the scum remover, treated water, from which floating contaminants are removed, filters the treated water and discharges the treated water, and receives a portion of the discharged treated water as backwashing water, and receives backwashing air injected from the outside to backwash the pressurized long-fiber filtering device; a submerged-type filter tank receiving and storing backwashing waste water discharged from the sewage filtration treatment unit and collecting sludge; a backwashing water filtration treatment unit mounted inside the submerged-type filter tank and including at least one submerged-type long-fiber filtering device, wherein the submerged-type long-fiber filtering device receives backwashing waste water from the submerged-type filter tank and filters the backwashing waste water to discharge filtered water, wherein a portion of the discharged filtered water is received as backwashing water, and backwashing air injected from the outside is received to backwash the submerged-type long-fiber filtering device to discharge the backwashing waste water to the submerged-type filter tank; and a sludge dehydrator receiving sludge from the submerged-type filter tank to discharge dehydrated cake.

The scum remover may include: a storage tank in which sewage supplied from the flowrate balancing tank is stored; a microbubble generator generating microbubbles and supplying the microbubbles into the storage tank to float floating contaminants from the sewage stored in the storage tank; a skimmer separating the floating contaminants floated to an upper portion of the storage tank by the microbubble generator; and a scum chamber storing the floating contaminants separated by the skimmer.

In each of the pressurized long-fiber filtering devices and the submerged-type long-fiber filtering devices, the plurality of the filtering devices are coupled to each other in the form of square modules each having a horizontally and vertically symmetrical structure.

Each of the pressurized long-fiber filtering devices and each of the submerged-type long-fiber filtering devices may include: a pressurized housing having an upper portion to which a transfer pump and a pipe are connected; a long-fiber filter medium fixedly mounted in an inner lower portion of the pressurized housing and filtering sewage, a porous penetration pipe, which is arranged in an inner lower portion of the long-fiber filter medium and fixedly mounted in the inner lower portion of the pressurized housing, and through which filtered treated water and backwashing water are discharged.

The pressurized housing may include: a long-fiber filter medium coupling plate having an opened central portion, wherein the long-fiber filter medium is coupled to an inner lower portion of the long-fiber filter medium coupling plate along an upper edge of the long-fiber filter medium coupling plate; a porous penetration pipe assembly plate having an opened central portion and arranged in a lower outer portion of the long-fiber filter medium coupling plate, wherein the porous penetration pipe is screw-coupled to the porous penetration pipe assembly plate; an air distribution plate having an opened central portion and arranged between the long-fiber filter medium coupling plate and the porous penetration pipe assembly plate, the air distribution plate receiving backwashing air injected from the outside through an air inlet formed in the pressurized housing to distribute the air into an upper inner side of the pressurized housing; a treated water separating plate having an opened central portion and arranged between the air distribution plate and the porous penetration pipe assembly plate, the treated water separating plate discharging treated water discharged from the porous penetration pipe to a treated water discharge outlet of the pressurized housing or receiving backwashing water through the treated water discharge outlet and supplying the backwashing water to the porous penetration pipe; a coupling screw coupling a lower portion of the porous penetration pipe and the porous penetration pipe assembly plate; and a leakage plug coupled to an outer portion of the coupling screw to prevent leakage of treated water.

The pressurized housing is divided into a non-groove area and a groove pipe area, the groove pipe area being arranged on the non-groove area and comprising a plurality of grooves, each having a predetermined diameter, formed from the long-fiber medium coupling plate to a predetermined height, wherein the predetermined height is about at least twice to ten times an inner diameter of the pressurized housing.

The inner diameter of the pressurized housing may be at least 15 mm, the predetermined height may be in a range from at least 30 mm to 150 mm, and a horizontal width of a cross-section of the groove may be in a range of at least 0.2 mm to 3 mm, and a depth of the groove may be in a range of at least 0.2 mm to 3 mm, and a distance between grooves may be in a range of at least 0.4 mm to 40 mm.

The long-fiber filter medium may include: a movable holder coupled to an upper end of long fiber that extends vertically and filters treated water and backwashing water; a fixed holder provided at a lower end of the long fiber and fixedly coupled to the pressurized housing; at least one inner holder in upper and lower portions, which is provided within the movable holder and the fixed holder and respectively coupled to both ends of the wound long fiber, wherein each of the movable holder, the inner holders, and the fixed holder each have an opened central portion so that treated water or backwashing water flows into or discharged therefrom, and central portions of the lower inner holder and the fixed holder are provided such that a lower portion of the porous penetration pipe is inserted into and coupled to the central portions.

A long fiber may be wound around a projection of the inner holder, and each inner holder is fixed to each of the movable holder and the fixed holder via an inclined protrusion to be coupled to each other.

According to another aspect of the present disclosure, a sewage treatment method of a sewage treatment system is provided.

The sewage treatment method of a sewage treatment system includes: receiving sewage from a flowrate balancing tank and injecting microbubbles to float floating contaminants contained in the sewage so as to remove the floating contaminants; filtering the sewage, from which floating contaminants are removed, by using at least one pressurized long-fiber filtering device, and discharging treated water; backwashing the pressurized long-fiber filtering device and filtering discharged backwashing wastewater by using at least one submerged-type long-fiber filtering device and returning the backwashing wastewater to the flowrate balancing tank; and concentrating and collecting backwashing wastewater discharged by backwashing the submerged-type long-fiber filtering device, in a submerged-type filter tank accommodating the submerged-type long-fiber filtering device so as to dehydrate and discharge the backwashing wastewater by using a sludge dehydrator.

The backwashing of the pressurized long-fiber filtering device or the submerged-type long-fiber filtering device may include: supplying backwashing water by using the pressurized long-fiber filtering device or the submerged-type long-fiber filtering device for at least 20 seconds to 300 seconds, to float the long-fiber filter medium of the submerged-type long-fiber filtering device, injecting only backwashing air for at least 10 seconds to 300 seconds, simultaneously injecting backwashing water and backwashing air for at least 10 seconds to 300 seconds, injecting only backwashing air again for at least 20 seconds to 360 seconds, injecting backwashing water and backwashing air again for at least 20 seconds to 360 seconds, and then injecting a functional chemical softening the long fiber of the long-fiber filter medium with backwashing water to backwash the pressurized long-fiber filtering device or the submerged-type long-fiber filtering device.

### Advantageous Effects of Disclosure

As described above, according to the sewage treatment system of the present disclosure, as a plurality of long-fiber filtering devices are used to treat sewage by direct filtration, sewage may be treated without using microorganisms, and greenhouse gases may be reduced without being greatly affected by a change in the flow of inflow sewage, or concentration or temperature change.

Also, a sewage treatment plant for the sewage treatment system according to the present disclosure may be constructed in a very small and movable structure compared to a process that uses microorganisms, thus providing economical benefits such as lower construction costs and operating costs and ultimately reduction in the public budget.

### DESCRIPTION OF THE DRAWINGS

FIG. 1 illustrates a structure of a sewage treatment system according to the present disclosure;

FIG. 2 illustrates a structure of a scum remover illustrated in FIG. 1;

FIG. 3 illustrates a structure of a sewage filtration treatment unit including a plurality of pressurized long-fiber filtering devices, illustrated in FIG. 1;

FIG. 4 illustrates a structure of the pressurized long-fiber filtering device illustrated in FIG. 3;

FIG. 5 illustrates a structure of a long-fiber filter medium illustrated in FIG. 4;

FIG. 6 is a cross-sectional view illustrating a structure of an inner holder illustrated in FIG. 5;

FIG. 7 is a cross-sectional view illustrating a structure of a movable holder illustrated in FIG. 5;

FIG. 8 is a cross-sectional view illustrating a structure of a fixed holder illustrated in FIG. 5;

FIG. 9 is a partial cross-sectional view illustrating a structure of a holder portion illustrated in FIG. 5;

FIG. 10 is a cross-sectional view illustrating a structure of a pressurized housing illustrated in FIG. 4;

FIG. 11 is a rear view illustrating a structure of a modular coupling structure of the pressurized housing illustrated in FIG. 10;

FIG. 12 illustrates a backwashing process of the sewage filtration treatment unit illustrated in FIG. 3;

FIG. 13 illustrates a filtration process of the sewage filtration treatment unit illustrated in FIG. 3;

FIG. 14 illustrates a structure of a backwashing water filtration treatment unit including a plurality of submerged-type long-fiber filtering devices, illustrated in FIG. 1;

FIG. 15 is a cross-sectional view illustrating a structure of a housing of the submerged-type long-fiber filtering devices illustrated in FIG. 14;

FIG. 16 is a cross-sectional view illustrating a structure of a porous penetration pipe illustrated in FIG. 14;

FIG. 17 illustrates a filtration process of the backwashing water filtration treatment unit illustrated in FIG. 14; and

FIG. 18 illustrates a backwashing process of the backwashing water filtration treatment unit illustrated in FIG. 14.

### BEST MODE

The present disclosure may be embodied in many different forms, and should not be construed as being limited to the embodiments set forth herein. These embodiments are provided so that this disclosure will be thorough and complete, and will fully convey the concept of the present disclosure to those skilled in the art. Thus, the shape of elements or the like in the drawings are exaggerated for clarity.

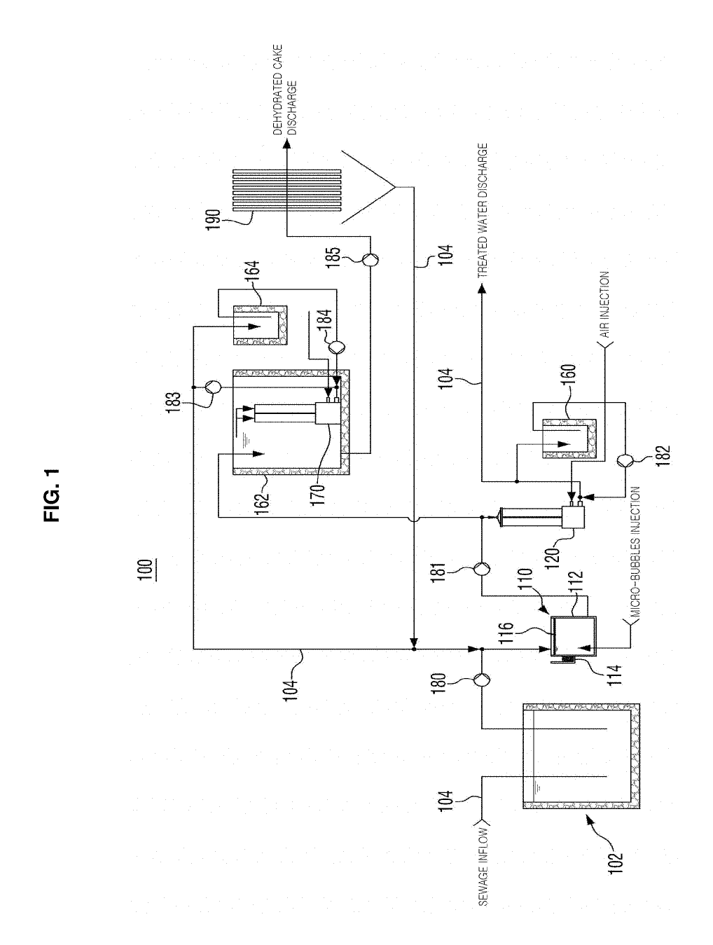

Hereinafter, the embodiments of the present disclosure will be described in detail with reference to FIGS. 1 through 18.

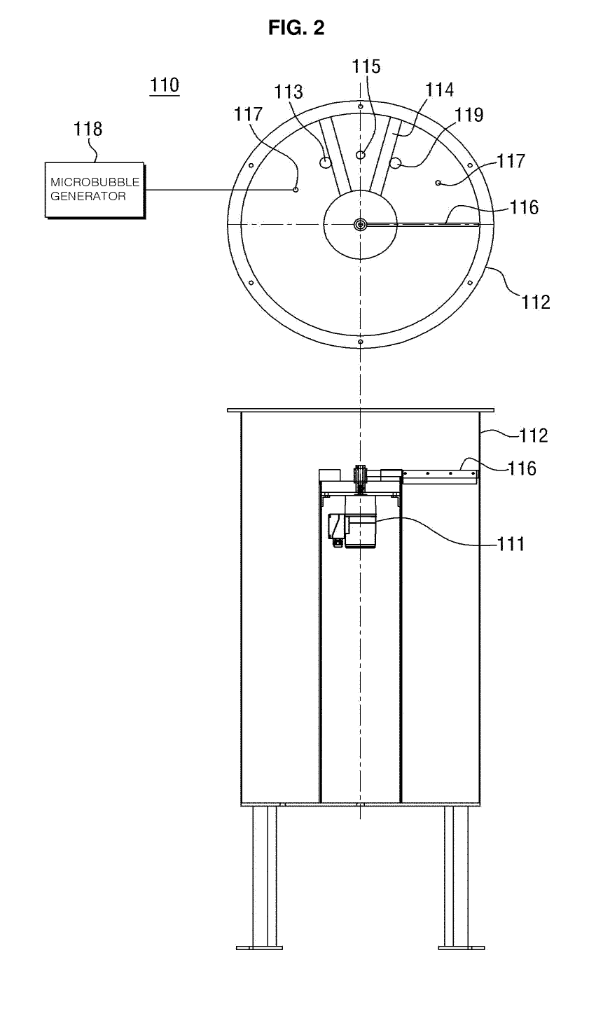

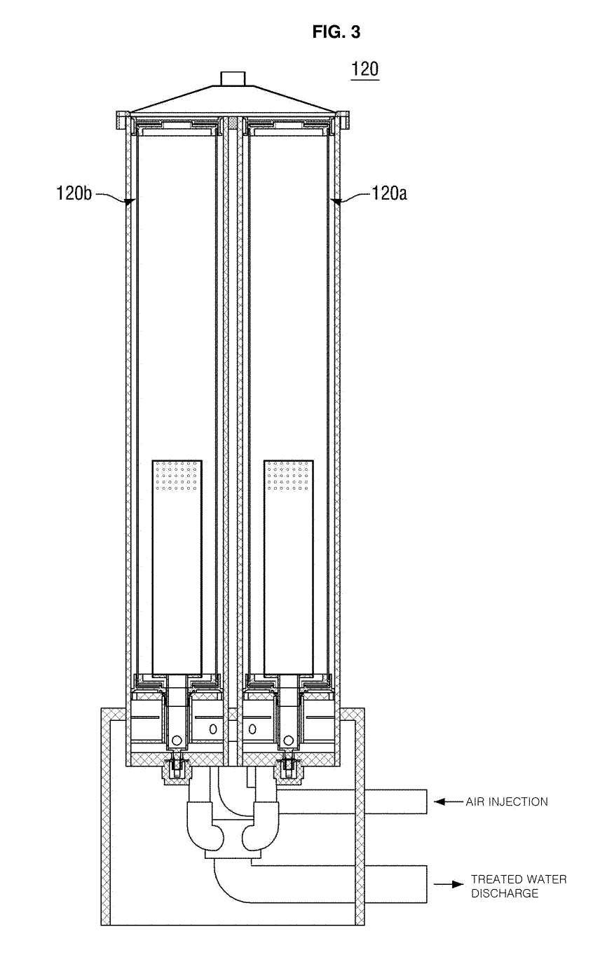

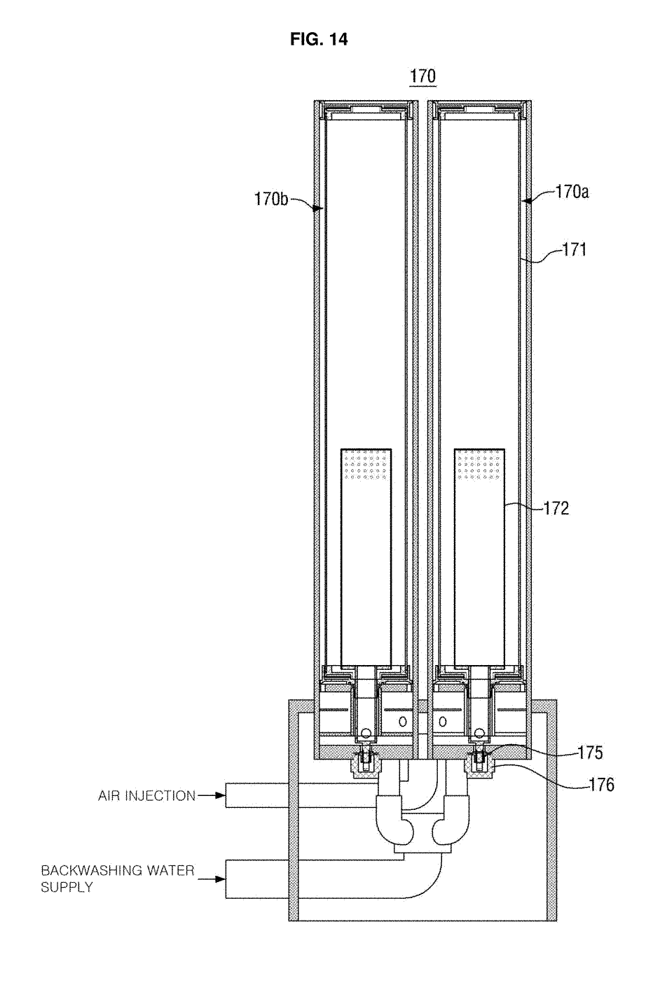

FIG. 1 illustrates a structure of a sewage treatment system according to the present disclosure. FIG. 2 illustrates a structure of a scum remover illustrated in FIG. 1. FIG. 3 illustrates a structure of a sewage filtration treatment unit including a plurality of pressurized long-fiber filtering devices, illustrated in FIG. 1. FIG. 14 illustrates a structure of a backwashing water filtration treatment unit including a plurality of submerged-type long-fiber filtering devices, illustrated in FIG. 1.

First, referring to FIG. 1, the sewage treatment system 100 according to the present disclosure uses a plurality of long-fiber filtering devices arranged in multiple stages to treat sewage by direct filtration. That is, the sewage treatment system 100 according to the present disclosure filters sewage by direct filtration by filtering inflowing sewage by using at least one pressurized long-fiber filtering device, and dehydrating and disposing of backwashing water of the sewage by using at least one submerged-type long-fiber filtering device.

To this end, the sewage treatment system 100 according to the present disclosure includes a flowrate balancing tank 102, a scum remover 110, a sewage filtration treatment unit 120 including at least one pressurized long-fiber filtering device (120a and 120b of FIG. 3), a first backwashing water storage tank 160, a submerged-type filter tank 162, a backwashing water filtration treatment unit 170 including at least one submerged-type long-fiber filtering device (170a and 170b of FIG. 14), a second backwashing water storage tank 164, and a sludge dehydrator 190. In addition, the sewage treatment system 100 according to the present disclosure includes a plurality of pipes 104 connecting the above-described components to each other to supply or discharge sewage, backwashing water, treated water, microbubbles, the air or the like, and a plurality of pressurized transfer pumps 180, 181, 182, 183, 184, and 185 respectively included in the pipes 104. In addition, the pipes 104 may include, for example, a supply pipe, a connection pipe, a transfer pipe, a branched pipe and/or a discharge pipe or the like, and a plurality of valves (not shown) may be respectively included in the pipes.

The flowrate balancing tank 102 is provided as a storage tank having a certain storage capacity and receiving a certain amount of inflow sewage through the supply pipe and store the sewage to adjust the throughput of sewage coming from the outside. A mechanical mixer (not shown) is installed in the flowrate balancing tank 102 to prevent sedimentation of floating matters of sewage. The flowrate balancing tank 102 according to the present embodiment has a storage capacity for storing inflow sewage for a certain period of time, for example, for about three hours. The flowrate balancing tank 102 supplies source water to the scum remover 110 by using a first transfer pump 180.

The first transfer pump 180 is connected to the connection pipe connecting the flowrate balancing tank 102 and the scum remover 110. The first transfer pump 180 performs pumping such that source water is supplied from the flowrate balancing tank 102 to the scum remover 110 via the connection pipe 104.

The scum remover 110 removes, from source water supplied from the flowrate balancing tank 102, floating contaminants such as oil, grease, and bubble. The scum remover 110 includes a storage tank 112 in which source water is stored, a scum chamber 114 temporarily storing floating contaminants separated from source water of the storage tank 112, a skimmer 116 separating floating contaminants from source water, and a microbubble generator 118 (FIG. 2) generating and supplying microbubble to the storage tank 112 to float floating contaminants from the source water stored in the storage tank 112.

The scum remover 110 according to the present embodiment includes the storage tank 112 included as a double circular tank 112 as illustrated in FIG. 2. The double circular tank 112 has a space in which source water is stored, and a portion of the space is partitioned by barriers to form the scum chamber 114. A source water inlet 113, a treated water discharge outlet 119, a plurality of microbubble injection inlets 117, and a floating material discharge outlet 115 are provided in an upper surface of the double circular tank 112. The skimmer 116 for removing floating materials such as oil, grease, and bubble or the like, that is, floating contaminants, is mounted in an upper central portion of the double circular tank 112.

The skimmer 116 is rotated about a vertical central line of the double circular tank 112 as a central axis, thereby separating floating contaminants floating in an upper portion of the double circular tank 112. The separated floating contaminants are temporarily stored in the scum chamber 114, and are discharged through the floating material discharge outlet 115 to the outside, for example, to a sludge concentration tank (not shown). To this end, the skimmer 116 is coupled to a skimmer rotation motor 111 on the central axis of the double circular tank 112 to receive a rotational force.

The microbubble generator 118 injects microbubbles into the double circular tank 112 through the microbubble injection inlets 117. Accordingly, the double circular tank 112 receives microbubbles from the microbubble generator 118 to thereby float floating contaminants such as oil, grease, and bubbles or the like included in source water, towards an upper portion of the double circular tank 112.

As the floating contaminants are floated, the scum remover 110 separates the floating contaminants by using the skimmer 116 and temporarily stores the floating contaminants in the scum chamber 114, and then transports the same to the sludge concentration tank (not shown). The scum remover 110 discharges treated water, from which floating contaminants are removed, through the treated water discharge outlet 119, and supplies the treated water to the sewage filtration treatment unit 120 through the second transfer pump 181. A portion of the treated water discharged from the scum remover 110 is supplied to the submerged-type filter tank 162.

The sewage filtration treatment unit 120 receives, from the scum remover 110, the treated water, from which floating contaminants are removed, performs sewage treatment on the treated water by a direct filtration method by using at least one pressurized long-fiber filtering device (120a and 120b of FIG. 3), and discharges the treated water. A portion of the discharged treated water is supplied to the first backwashing water storage tank 160 so as to be used as backwashing water. In addition, the sewage filtration treatment unit 120 receives backwashing water from the first backwashing water storage tank 160 through the third transfer pump 182, and receives backwashing air injected from the outside to backwash the at least one pressurized long-fiber filtering device 120a and 120b.

The sewage filtration treatment unit 120 according to the present embodiment includes a plurality of pressurized long-fiber filtering devices 120a and 120b that are coupled in a square modular shape having a horizontally and vertically symmetrical structure as illustrated in FIG. 3. For example, the pressurized long-fiber filtering devices 120a and 120b are coupled to each other in a square modular structure including a plurality of devices provided symmetrically to each other in a square number of 2, for example, 2×2 (a), 4×4(b).

The first backwashing water storage tank 160 receives a portion of the treated water discharged from the sewage filtration treatment unit 120 and stores the same, and supplies backwashing water to the sewage filtration treatment unit 120 again through the third transfer pump 183.

The submerged-type filter tank 162 receives backwashing water from the sewage filtration treatment unit 120, and collects sludge, that is, sedimentation solids and floating solids. To this end, in the submerged-type filter tank 162, a lower solid collecting plate for collecting sedimentation solids and an upper solid collecting plate for collecting floating solids may be mounted.

The submerged-type filter tank 162 includes a backwashing water filtration treatment unit 170 that filters backwashing water to discharge filtered water. In addition, the submerged-type filter tank 162 supplies filtered water obtained by filtering backwashing water by using the backwashing water filtration treatment unit 170, to the scum remover 110 or the second backwashing water storage tank 164 through the fourth transfer pump 183. In addition, the submerged-type filter tank 162 supplies sludge to the sludge dehydrator 190 through the fifth transfer pump 184.

The backwashing water filtration treatment unit 170 includes at least one submerged-type long-fiber filtering device 170a and 170b as illustrated in FIG. 14. In the backwashing water filtration treatment unit 170, each of the submerged-type long-fiber filtering devices 170a and 170b receives backwashing water stored in the submerged-type filter tank 162 and directly filters the backwashing water. Also, in the backwashing water filtration treatment unit 170, each of the submerged-type long-fiber filtering devices 170a and 170b receives backwashing water from the second backwashing water storage tank 164 and receives backwashing air injected from the outside to perform backwashing by a direct filtration method.

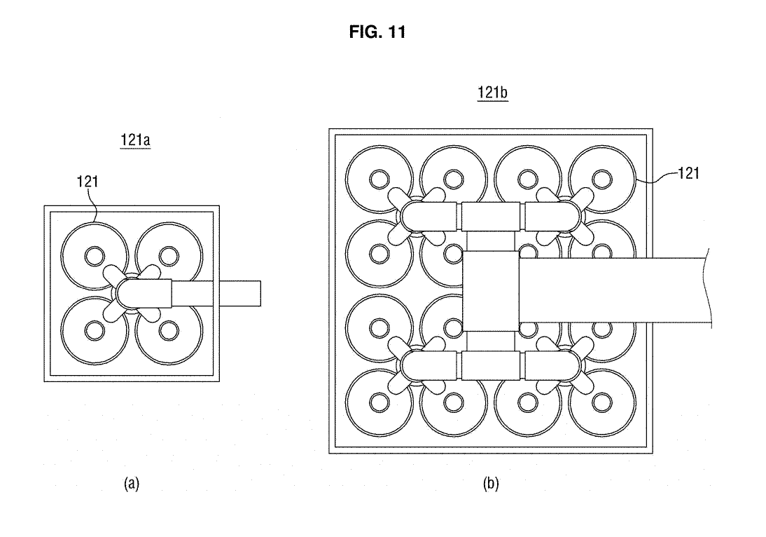

In the backwashing water filtration treatment unit 170 according to the present embodiment, the plurality of submerged-type long-fiber filtering devices 170a and 170b are coupled in the form of square modules having a horizontally and vertically symmetrical structure. That is, the submerged-type long-fiber filtering devices 170a and 170b are coupled in a same arrangement structure as the pressurized long-fiber filtering devices 120a and 120b, for example, as illustrated in FIG. 11, in a square modular structure including a plurality of devices provided symmetrically to each other in a square number of 2, for example, 2×2(a) or 4×4(b).

The submerged-type long-fiber filtering devices 170a and 170b according to the present embodiment have a structure that is approximately similar or identical to that of the pressurized long-fiber filtering devices 120a and 120b. That is, the submerged-type long-fiber filtering devices 170a and 170b include a pressurized housing 171, a porous penetration pipe 172, a long-fiber filter medium, and the like. The long-fiber filter medium 123 is inserted downwards from above after opening the cover of the pressurized housing 171, and is coupled to the pressurized housing 171 via the porous penetration pipe 172, and is fixed via a coupling screw 175 of the porous penetration pipe 172, and prevents leakage of treated water via a leakage plug 176.

The second backwashing water storage tank 164 receives a portion of treated water discharged from the submerged-type filter tank 162 and stores the same, and supplies backwashing water to the sewage filtration treatment unit 120 again through the fifth transfer pump 184.

The sludge dehydrator 190 receives sludge from the submerged-type filter tank 162 through the sixth transfer pump 185 and dehydrates the sludge to discharge dehydrated cake. Here, the dehydrated treated water is collected again to the scum remover 110 through the connecting pipe 104.

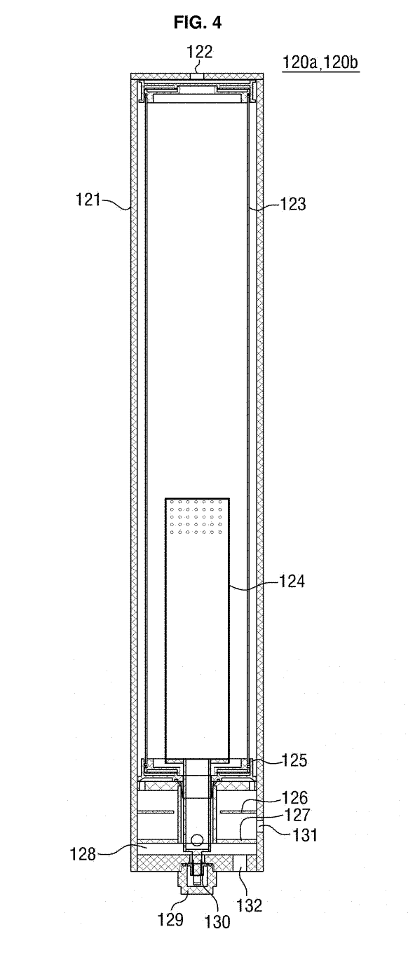

In detail, the structure of the pressurized long-fiber filtering device according to the embodiment of the present disclosure will be described in detail with reference to FIGS. 4 through 10.

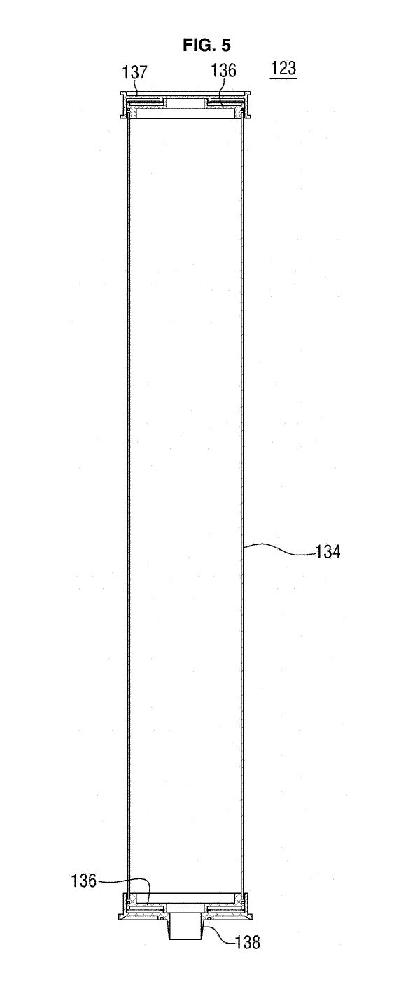

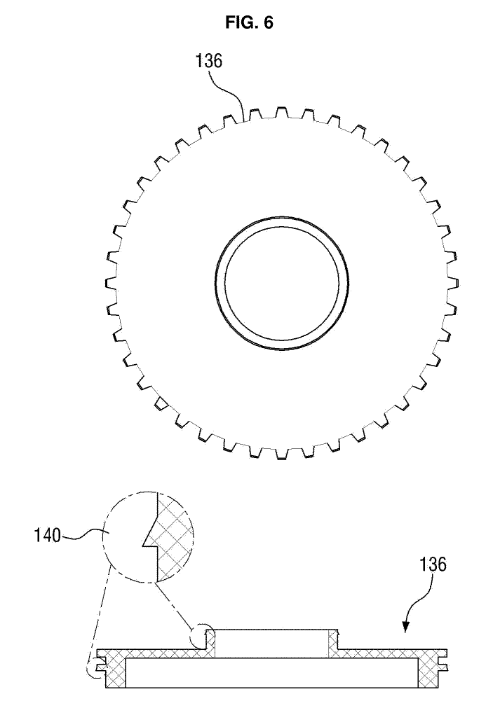

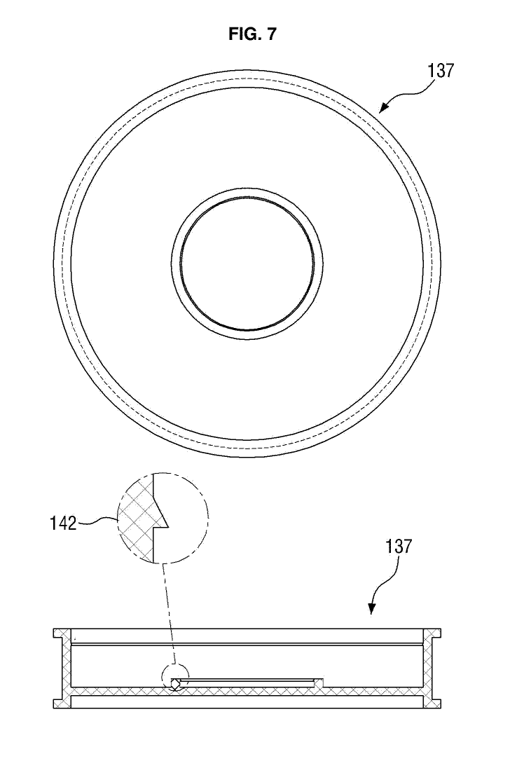

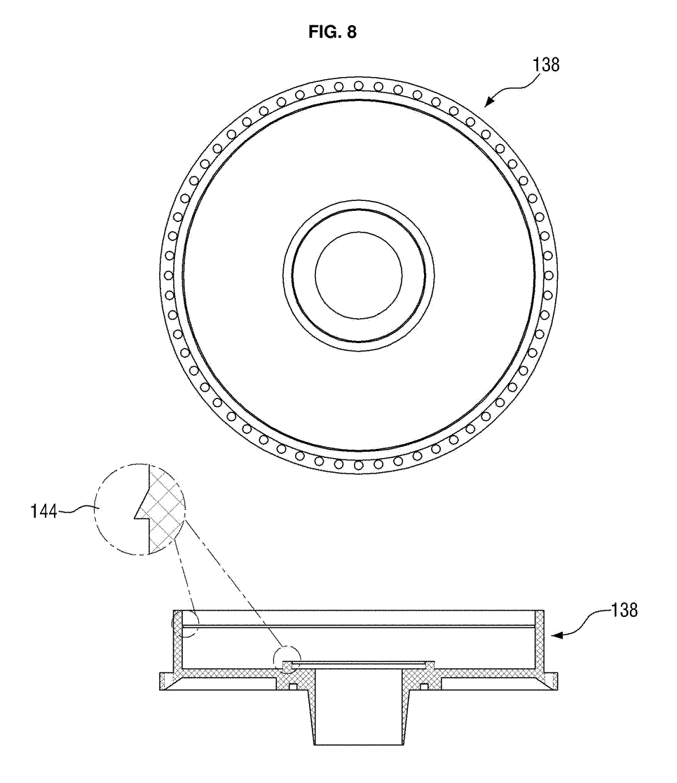

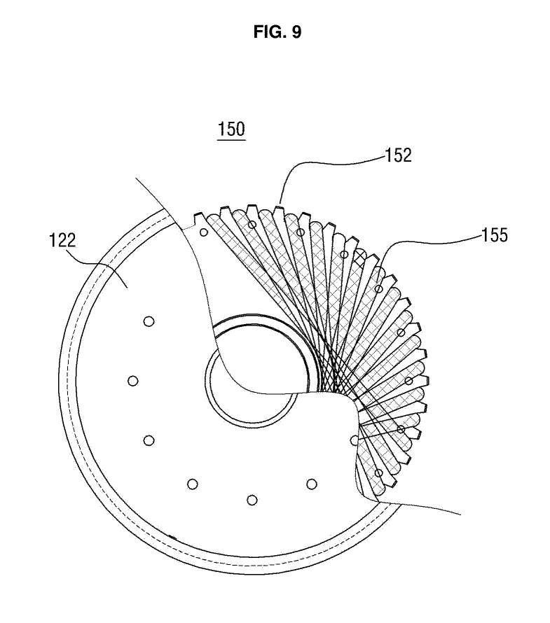

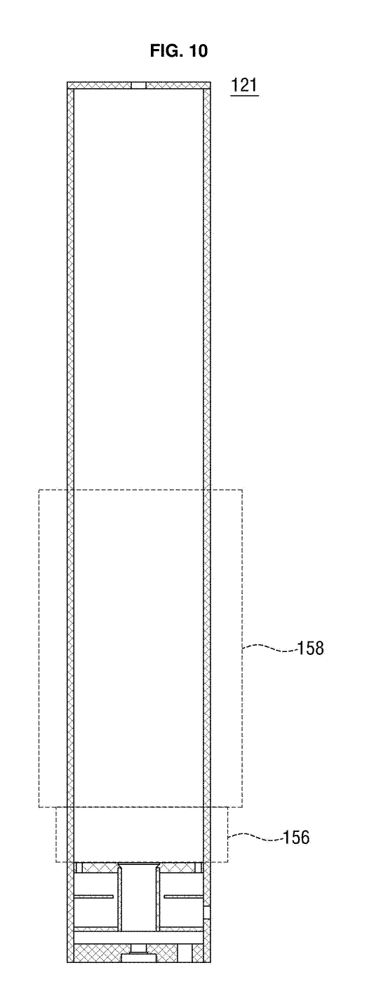

FIG. 4 illustrates a structure of the pressurized long-fiber filtering device illustrated in FIG. 3. FIG. 5 illustrates a structure of a long-fiber filter medium illustrated in FIG. 4. FIG. 6 is a cross-sectional view illustrating a structure of an inner holder illustrated in FIG. 5. FIG. 7 is a cross-sectional view illustrating a structure of a movable holder illustrated in FIG. 5. FIG. 8 is a cross-sectional view illustrating a structure of a fixed holder illustrated in FIG. 5. FIG. 9 is a partial cross-sectional view illustrating a structure of a holder portion illustrated in FIG. 5. FIG. 10 is a cross-sectional view illustrating a structure of a pressurized housing illustrated in FIG. 4.

Referring to FIGS. 4 through 10, the pressurized long-fiber filtering device 120a and 120b includes a pressurized housing 121 and a cover 122. The pressurized housing 121 has a cylindrical shape having an open upper portion, and the open upper portion is coupled to the cover 122, and the long-fiber filter medium 123 and the porous penetration pipe 124 are accommodated and coupled inside the pressurized housing 121. The cover 122 has an open central portion so that when the cover 122 is coupled to the open upper portion of the pressurized housing 121, treated water flows in a downward direction or backwashing water is discharged in an upward direction.

The pressurized housing 121 is provided in the form of, for example, a pipe-shaped pressure container, and in an inner lower portion thereof, a long-fiber filter medium coupling plate 125 for coupling a long-fiber filter medium 134 and the porous penetration pipe 124, and a porous penetration pipe assembly plate 128 are provided. In addition, the pressurized housing 121 includes an air distribution plate 126, a treated water separating plate 127, a leakage plug 129, and a coupling screw 130. In addition, the pressurized housing 121 includes an air inlet 131 at a lateral side and a treated water discharge outlet 132.

The pressurized housing 121 according to this embodiment is divided into a non-groove area 156 and a groove pipe area 158, which is arranged on the non-groove area 156 and in which a plurality of grooves of a predetermined diameter are formed, as illustrated in FIG. 10. The groove pipe area 158 has grooves from the long-fiber filter medium coupling plate 125 to a predetermined height. In this case, the predetermined height may be about twice to ten times an inner diameter of the pressurized housing 121. For example, when the inner diameter of the pressurized housing 121 is about 15 mm, the height may be about 30 to 150 mm, and a horizontal width of a cross-section of a groove may be about 0.2 to 3 mm, and a depth of the groove may be in a range of about 0.2 to 3 mm, and a distance between grooves may be in a range of about 0.4 to 40 mm.

As illustrated in FIG. 5, the long-fiber filter medium 123 includes a movable holder 137 coupled to an upper end of the long fiber 134 that extends vertically and filters treated water and backwashing water, a fixed holder 138 that is provided at a lower end of the long fiber 134 and fixedly coupled to the pressurized housing 121, and at least one inner holder 136 in upper and lower portions, which is provided within the movable holder 137 and the fixed holder 138 and respectively coupled to both ends of the long fiber 134. The movable holder 137, the inner holder 136 in the upper and lower portions, and the fixed holder 138 each have an opened central portion so that treated water or backwashing water flows into or discharged therefrom, and central portions of the lower inner holder 136 and the fixed holder 138 are provided such that a protruded lower portion of the porous penetration pipe 124 is inserted into and coupled to the central portions.

The long-fiber filter medium 123 is inserted downwards from above after opening the cover 122 of the pressurized housing 121, and is coupled to the pressurized housing 121 via the porous penetration pipe 124, and is fixed via a coupling screw 130 of the porous penetration pipe 124, and prevents leakage of treated water via a leakage plug 129.

In the present embodiment, each of the inner holders 136 in the upper and lower portions is forcibly compressed with respect to the movable holder 137 via inclined protrusions 140, 142 as illustrated in FIGS. 6 and 7, and the inner holders 136 are forcibly compressed with respect to the fixed holder 138 via inclined protrusions 140, 144 as illustrated in FIGS. 6 and 8. In addition, the long fiber 134, 154 is wound between projections 152 at the circumference of each of the inner holders 136 in the upper and lower portions at the both ends as illustrated in FIG. 9, and long-fiber filter medium 150 is coupled to the movable holder 137 and the fixed holder 138 in each of the upper portion and the lower portion of the inner holders 136 in the upper and lower portions. In addition, when a plurality of the inner holders 136 in the upper and lower portions are provided, the long-fiber filter medium 123 may have a structure in which the plurality of inner holders 136 in the upper and lower portions are coupled in a layered manner, and the movable holder 137 and the fixed holder 138 are coupled to the inner holders 136 in the upper and lower portions that are in an outermost portion.

In the porous penetration pipe 124, a plurality of holes passing through an upper portion thereof are formed, and a lower portion of the porous penetration pipe 124 is inserted into and coupled to the inner holder 136 in the lower portion and the fixed holder 138. A lower center of the porous penetration pipe 124 is coupled to a lower portion of the pressurized housing 121 via a coupling screw 130. The porous penetration pipe 124 receives, through the holes, a filtered solution filtered by the long-fiber filter medium 123 inside the pressurized housing 121, and discharges the solution to the outside and to the first backwashing water storage tank 160 through the holes in the lower portion.

The long-fiber filter medium coupling plate 125 has an opened central portion, and the long-fiber filter medium 123 is coupled to an upper edge of the long-fiber filter medium coupling plate 125. The air distribution plate 126 receives backwashing air injected from the outside through the air inlet 131 and distributes the air into an upper inner side of the pressurized housing 121. The treated water separating plate 127 is arranged on an inner lower surface of the pressurized housing 121 and configured to separate a flow passage of backwashing air injected from the air inlet 131, and discharge the treated water discharged from the porous penetration pipe 124 to the treated water discharge outlet 132.

The porous penetration pipe assembly plate 128 is provided on a lower surface of the pressurized housing 121 and includes a through hole in a center thereof, and is configured such that the porous penetration pipe 124 is screw-coupled to the coupling screw 130 through the through hole. In addition, the treated water discharge outlet 132 is formed at a side of the porous penetration pipe assembly plate 128. The leakage plug 129 is coupled to a lower external lateral surface of the pressurized housing 121 in a lower outer portion of the porous penetration pipe 124, to which the coupling screw 130 is coupled, that is, to an external lateral surface of the porous penetration pipe assembly plate 128 to thereby prevent leakage of treated water to the outside. The coupling screw 130 is screw-coupled to a lower portion of the porous penetration pipe 124. The air inlet 131 receives backwashing air injected from the outside and injects the air into the pressurized housing through the air distribution plate 126. The treated water discharge outlet 132 discharges the treated water discharged from the porous penetration pipe 124 to the outside and to the first backwashing water storage tank 160. In addition, the treated water discharge outlet 132 receives backwashing water from the first backwashing water storage tank 160 and supplies the backwashing water in a reverse order to the route of the treated water. The air inlet 131 and the treated water discharge outlet 132 described above have a symmetrically distributed structure in accordance with an arrangement of the plurality of pressurized long-fiber filtering devices 120a and 120b.

FIG. 11 is a rear view illustrating a structure of a modular coupling structure of the pressurized housing illustrated in FIG. 10.

Referring to FIG. 11, in the sewage filtration treatment unit 120 according to this embodiment, a plurality of pressurized long-fiber filtering devices 120a and 120b are provided in the form of square modules that are each horizontally and vertically symmetrical. Accordingly, a plurality of pressurized housings 121a, 121b of the pressurized long-fiber filtering devices 120a and 120b are provided symmetrically to each other. For example, when four pressurized long-fiber filtering devices 120a and 120b are provided, the pressurized housings 121a have a 2×2(a) arrangement, and when sixteen pressurized long-fiber filtering devices 120a and 120b are provided, the pressurized housings 121a have a 4×4(b) arrangement. Accordingly, in the sewage filtration treatment unit 120, pressurized long-fiber filtering devices 120a and 120b provided in a square number of 2 are coupled in a square modular form.

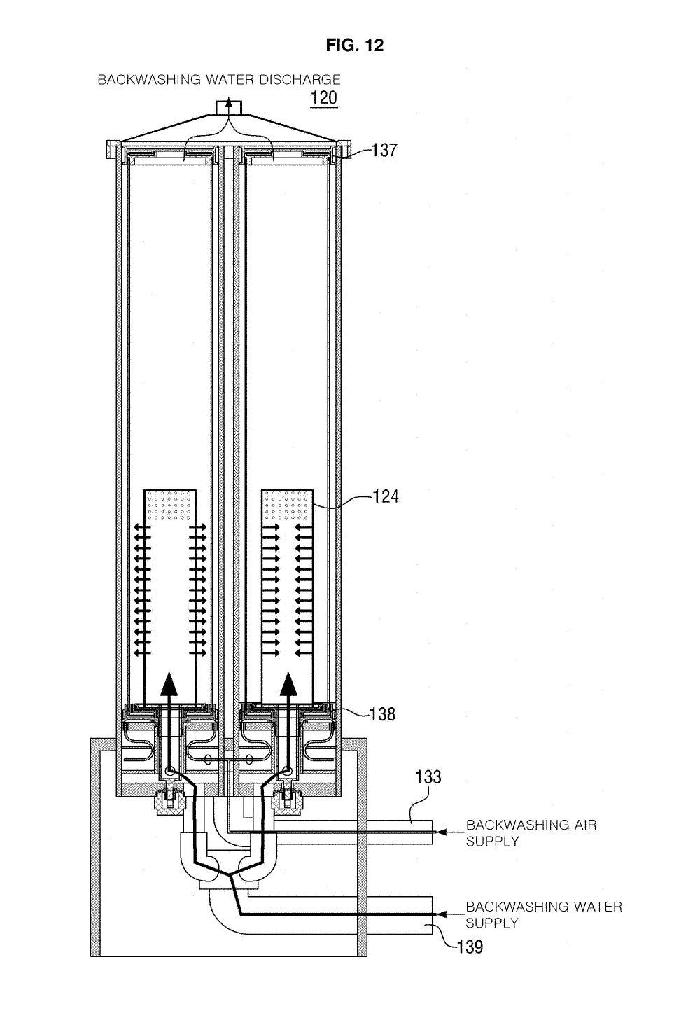

FIG. 12 illustrates a backwashing process of the sewage filtration treatment unit illustrated in FIG. 3.

Referring to FIG. 12, the sewage filtration treatment unit 120 first performs a backwashing process of backwashing the long-fiber filter medium 123 of the pressurized long-fiber filtering devices 120a and 120b.

That is, in the backwashing process, backwashing water is supplied through a backwashing water supply inlet 139 for a certain period of time, for example, for about 20 to 300 seconds to float the long-fiber filter medium 123, and then only backwashing air is injected for a certain period of time, for example, for about 10 to 300 seconds. Here, as the backwashing water supply inlet 139, the treated water discharge outlet 132 of the pressurized long-fiber filtering devices 120a and 120b is used. Also, in the backwashing process, backwashing water and backwashing air are simultaneously injected for a certain period, for example, for about 10 to 300 seconds. Also, in the backwashing process, only backwashing air is injected again through the air inlet 131 for a certain period of time, for example, for about 20 to 360 seconds, and then backwashing water and backwashing air are injected again for about 20 to 360 seconds. Here, backwashing wastewater is discharged through an upper portion of the pressurized long-fiber filtering devices 120a and 120b to the submerged-type filter tank 162. Next, in the backwashing process, a functional chemical that softens long fiber is injected with backwashing water to cleanse the pressurized long-fiber filtering devices 120a and 120b.

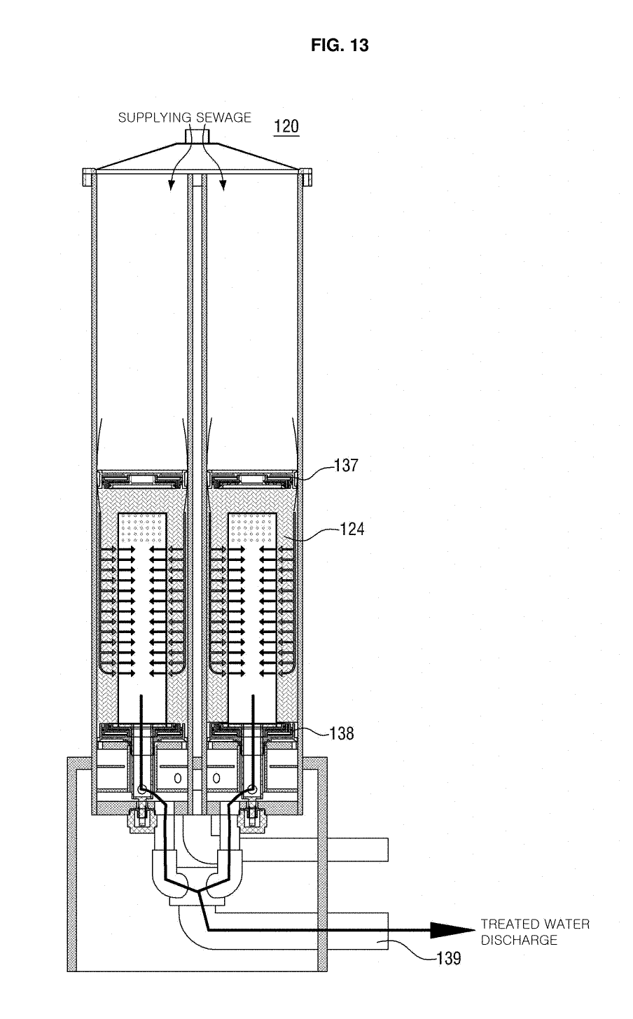

FIG. 13 illustrates a filtration process of the sewage filtration treatment unit illustrated in FIG. 3.

Referring to FIG. 13, when the backwashing process is completed, the sewage filtration treatment unit 120 performs a filtration process.

That is, in the sewage filtration treatment unit 120, sewage flows from the scum remover 110 into the upper portion of the pressurized long-fiber filtering devices 120a and 120b via the second transfer pump 181, and the movable holder 137 is compressed to a lower portion of the long fiber filter medium 123. The sewage filtration treatment unit 120 filters sewage via the compressed long-fiber filter medium 123, and after the filtered treated water passes the porous penetration pipe 124, the water is discharged to the outside through the backwashing water supply inlet 139 serving as the treated water discharge pipe in the lower portion. Next, after performing a filtration process for a certain period of time, a backwashing process is performed again, and backwashing wastewater created here is transported to the submerged-type filter tank 162.

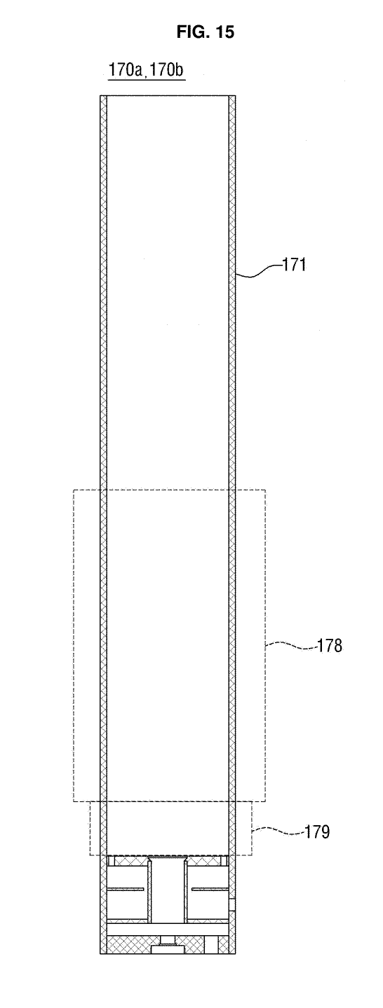

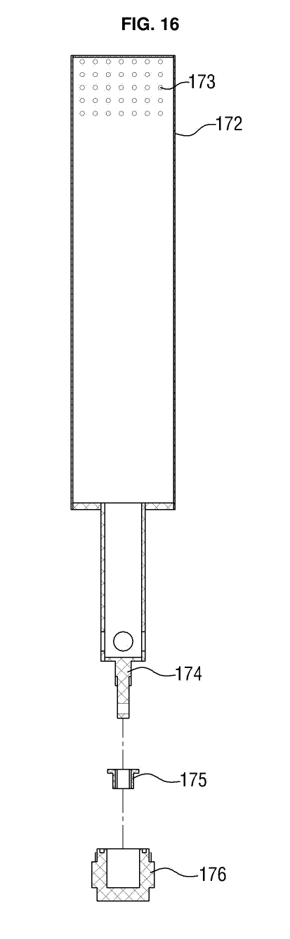

Further, FIG. 15 is a cross-sectional view illustrating a structure of the submerged-type long-fiber filtering device illustrated in FIG. 14. FIG. 16 is a cross-sectional view illustrating a structure of the porous penetration pipe illustrated in FIG. 14.

Referring to FIGS. 15 and 16, the submerged-type long-fiber filtering device 170a and 170b according to the present embodiment has a structure that is approximately similar or identical to that of the pressurized long-fiber filtering device 120a and 120b.

For example, the submerged-type long-fiber filtering device 170a and 170b includes a pressurized housing 171 and a cover. The pressurized housing 171 has a cylindrical shape having an open upper portion, and the open upper portion is coupled to the cover, and long-fiber filter medium and the porous penetration pipe 172 are accommodated and coupled inside the pressurized housing 171. The cover has an open central portion so that when the cover is coupled to the open upper portion of the pressurized housing 121, treated water flows in a downward direction or backwashing water is discharged in an upward direction.

The pressurized housing 171 is provided in the form of, for example, a pipe-shaped pressure container, and in an inner lower portion thereof, a long-fiber filter medium coupling plate for coupling a long-fiber filter medium and the porous penetration pipe 172, and a porous penetration pipe assembly plate are provided. In addition, the pressurized housing 171 includes an air distribution plate, a treated water separating plate, a leakage plug, and a coupling screw. In addition, the pressurized housing 171 includes an air inlet at a lateral side and a treated water discharge outlet.

Also, the pressurized housing 171 is divided into a non-groove area 179 and a groove pipe area 178, which is arranged on the non-groove area 179 and in which a plurality of grooves of a predetermined diameter are formed. The groove pipe area 178 has grooves from the long-fiber filter medium coupling plate to a predetermined height. In this case, the predetermined height may be about twice to ten times an inner diameter of the pressurized housing 171. For example, when the inner diameter of the pressurized housing 171 is about 15 mm, the height may be about 30 to 150 mm, and a horizontal width of a cross-section of a groove may be about 0.2 to 3 mm, and a depth of the groove may be in a range of about 0.2 to 3 mm, and a distance between the grooves may be in a range of about 0.4 to 40 mm.

In the porous penetration pipe 172, a plurality of holes 173 passing through an upper portion thereof are formed, and a lower center 174 is inserted into a lower inner holder and a fixed holder, and the porous penetration pipe 172 is coupled to the lower portion of the pressurized housing 171 via a coupling screw 175, and a leakage plug 176 is coupled to a lower outer portion of the pressurized housing 171.

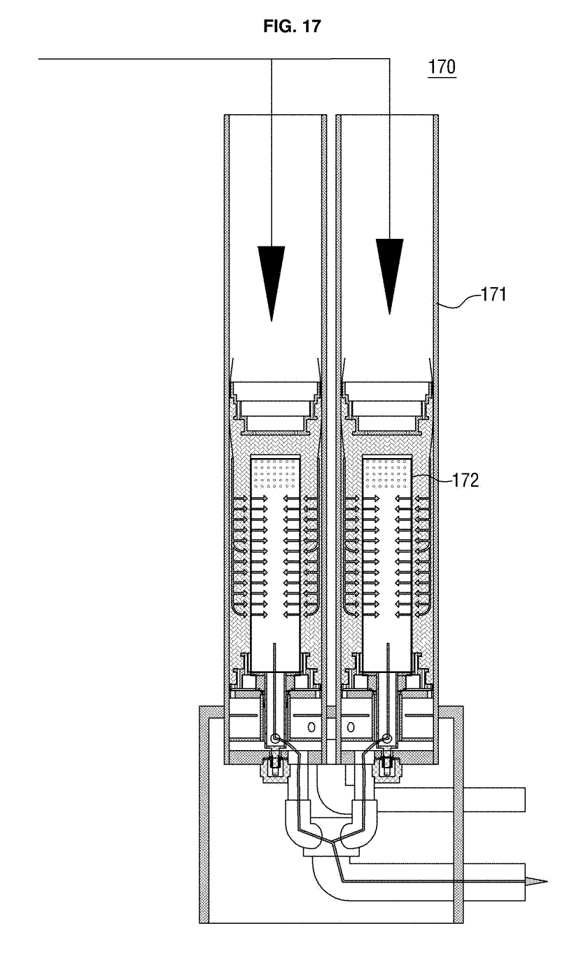

FIG. 17 illustrates a filtration process of the backwashing water filtration treatment unit illustrated in FIG. 14.

Referring to FIG. 17, during a filtration process of the backwashing water filtration treatment unit 170, backwashing wastewater is supplied from the submerged-type filter tank 162 through to an upper portion of the submerged-type long-fiber filtering devices 170a and 170b, and the backwashing wastewater is filtered through the long-fiber filter medium and the porous penetration pipe 172 by using an absorption force of the fourth transfer pump 183 to discharge filtered water. The filtered water discharged in the filtration process is discharged to the second backwashing water storage tank 164 and the scum remover 110 through the fourth transfer pump 183.

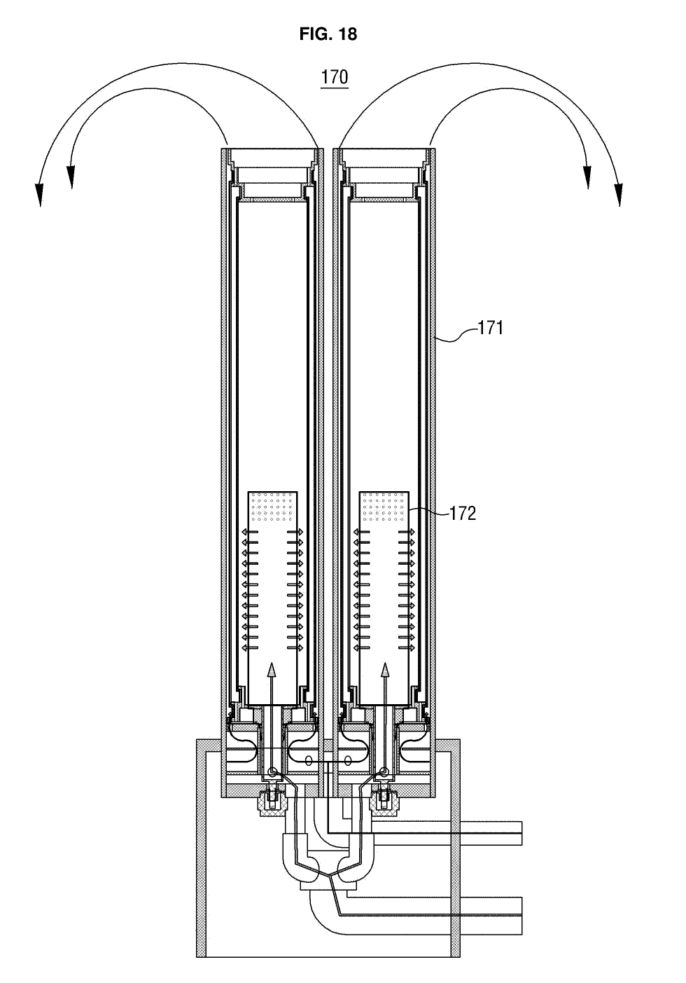

In addition, FIG. 18 illustrates a backwashing process of the backwashing water filtration treatment unit illustrated in FIG. 14.

Referring to FIG. 18, in a backwashing process of the backwashing water filtration treatment unit 170, backwashing water is supplied from the second backwashing water storage tank 164 into a backwashing water supply inlet by using the fifth transfer pump 184 for a certain period of time, for example, for about 20 to 300 seconds, to float the long-fiber filter medium, and then only backwashing air is injected into the air inlet for a certain period of time, for example, for about 10 to 300 seconds. The backwashing water supply inlet is the treated water discharge outlet of the submerged-type long-fiber filtering device 170a and 170b. Also, in the backwashing process, backwashing water and backwashing air are simultaneously injected for a certain period, for example, for 10 to 300 seconds. Also, in the backwashing process, only backwashing air is injected again through the air inlet for a certain period of time, for example, for about 20 to 360 seconds, and then backwashing water and backwashing air are injected again. Here, backwashing wastewater is discharged through the upper portion of the submerged-type long-fiber filtering devices 170a and 170b to the submerged-type filter tank 162. Next, in the backwashing process, a functional chemical that softens long fiber is injected with backwashing water to cleanse the submerged-type long-fiber filtering devices 170a and 170b.

When the backwashing process is completed as described above, the submerged-type filter tank 162 discharges the backwashing wastewater to the sludge dehydrator 190 by using the sixth transfer pump 185 to thereby discharge dehydrated cake.

Accordingly, the sewage treatment system 100 according to the present disclosure receives sewage and injects microbubbles into the sewage and mixes the same to float floating contaminants in the sewage to thereby remove them, and filters the sewage, from which the floating contaminants are removed, by using at least one pressurized long-fiber filtering device to discharge treated water. In addition, the sewage treatment system 100 backwashes the pressurized long-fiber filtering device by using treated water discharged from the at least one submerged-type long-fiber filtering device, as backwashing water, and filters backwashing wastewater discharged from the pressurized long-fiber filtering device to discharge backwashing water and collects backwashing wastewater to discharge sludge. Here, the sewage treatment system 100 backwashes the submerged-type long-fiber filtering device by using the discharged backwashing water to collect discharged backwashing wastewater to further discharge sludge.

While the structure and operation of the sewage treatment system according to the present disclosure have been illustrated based on the detailed description and the drawings, the above is merely description of embodiments, and various changes and modifications may be made therein without departing from the spirit and scope of the present disclosure.

### EXPLANATION OF REFERENCE NUMERALS

100: sewage treatment system
102: flowrate balancing tank
110: scum remover
114: scum chamber
116: skimmer
120: sewage filtration treatment unit
120a and 120b: pressurized long-fiber filtering device
160, 164: backwashing water storage tank
162: submerged-type filter tank
170: backwashing water filtration treatment unit
170a and 170b: submerged-type long-fiber filtering device
190: sludge dehydrator

1. A sewage treatment system comprising:
a flowrate balancing tank receiving sewage flowing from the outside and storing the sewage;
a scum remover removing floating contaminants from sewage supplied from the flowrate balancing tank;
a sewage filtration treatment unit comprising at least one pressurized long-fiber filtering device, wherein the pressurized long-fiber filtering device receives, from the scum remover, treated water, from which floating contaminants are removed, filters the treated water and discharges the treated water, and receives a portion of the discharged treated water as backwashing water, and receives backwashing air injected from the outside to backwash the pressurized long-fiber filtering device;
a submerged-type filter tank receiving and storing backwashing waste water discharged from the sewage filtration treatment unit and collecting sludge;
a backwashing water filtration treatment unit mounted inside the submerged-type filter tank and comprising at least one submerged-type long-fiber filtering device, wherein the submerged-type long-fiber filtering device receives backwashing waste water from the submerged-type filter tank and filters the backwashing waste water to discharge filtered water, wherein a portion of the discharged filtered water is received as backwashing water, and backwashing air injected from the outside is received to backwash the submerged-type long-fiber filtering device to discharge the backwashing waste water to the submerged-type filter tank; and
a sludge dehydrator receiving sludge from the submerged-type filter tank to discharge dehydrated cake.

2. The sewage treatment system of claim 1, wherein the scum remover comprises:
a storage tank in which sewage supplied from the flowrate balancing tank is stored;
a microbubble generator generating microbubbles and supplying the microbubbles into the storage tank to float floating contaminants from the sewage stored in the storage tank;
a skimmer separating the floating contaminants floated to an upper portion of the storage tank by the microbubble generator; and
a scum chamber storing the floating contaminants separated by the skimmer.

3. The sewage treatment system of claim 1, wherein in each of the pressurized long-fiber filtering devices and the submerged-type long-fiber filtering devices,
the plurality of the filtering devices are coupled to each other in the form of square modules each having a horizontally and vertically symmetrical structure.

4. The sewage treatment system of claim 3, wherein each of the pressurized long-fiber filtering devices and each of the submerged-type long-fiber filtering devices comprise:
a pressurized housing having an upper portion to which a transfer pump and a pipe are connected;
a long-fiber filter medium fixedly mounted in an inner lower portion of the pressurized housing and filtering sewage,
a porous penetration pipe, which is arranged in an inner lower portion of the long-fiber filter medium and fixedly mounted in the inner lower portion of the pressurized housing, and through which filtered treated water and backwashing water are discharged.

5. The sewage treatment system of claim 4, wherein the pressurized housing comprises:
a long-fiber filter medium coupling plate having an opened central portion, wherein the long-fiber filter medium is coupled to an inner lower portion of the long-fiber filter medium coupling plate along an upper edge of the long-fiber filter medium coupling plate;
a porous penetration pipe assembly plate having an opened central portion and arranged in a lower outer portion of the long-fiber filter medium coupling plate, wherein the porous penetration pipe is screw-coupled to the porous penetration pipe assembly plate;
an air distribution plate having an opened central portion and arranged between the long-fiber filter medium coupling plate and the porous penetration pipe assembly plate, the air distribution plate receiving backwashing air injected from the outside through an air inlet formed in the pressurized housing to distribute the air into an upper inner side of the pressurized housing;
a treated water separating plate having an opened central portion and arranged between the air distribution plate and the porous penetration pipe assembly plate, the treated water separating plate discharging treated water discharged from the porous penetration pipe to a treated water discharge outlet of the pressurized housing or receiving backwashing water through the treated water discharge outlet and supplying the backwashing water to the porous penetration pipe;
a coupling screw coupling a lower portion of the porous penetration pipe and the porous penetration pipe assembly plate; and
a leakage plug coupled to an outer portion of the coupling screw to prevent leakage of treated water.

6. The sewage treatment system of claim 5, wherein the pressurized housing is divided into a non-groove area and a groove pipe area, the groove pipe area being arranged on the non-groove area and comprising a plurality of grooves, each having a predetermined diameter, formed from the long-fiber medium coupling plate to a predetermined height,
wherein the predetermined height is about at least twice to ten times an inner diameter of the pressurized housing.

7. The sewage treatment system of claim 6, wherein when the inner diameter of the pressurized housing is at least 15 mm, the predetermined height is in a range from at least 30 mm to 150 mm, and a horizontal width of a cross-section of the groove is in a range of at least 0.2 mm to 3 mm, and a depth of the groove is in a range of at least 0.2 mm to 3 mm, and a distance between the grooves is in a range of at least 0.4 mm to 40 mm.

8. The sewage treatment system of claim 4, wherein the long-fiber filter medium comprises:
a movable holder coupled to an upper end of long fiber that extends vertically and filters treated water and backwashing water;
a fixed holder provided at a lower end of the long fiber and fixedly coupled to the pressurized housing;
at least one inner holder in upper and lower portions, which is provided within each of the movable holder and the fixed holder and respectively coupled to both ends of the wound long fiber,
wherein each of the movable holder, the inner holders, and the fixed holder has an opened central portion so that treated water or backwashing water flows into or is discharged therefrom, and central portions of the lower inner holder and the fixed holder are provided such that a lower portion of the porous penetration pipe is inserted into and coupled to the central portions.

9. The sewage treatment system of claim 8, wherein a long fiber is wound around a projection of the inner holder, and each inner holder is fixed to each of the movable holder and the fixed holder via an inclined protrusion to be coupled to each other.

10. A sewage treatment method of a sewage treatment system, the sewage treatment method comprising:
receiving sewage from a flowrate balancing tank and injecting microbubbles to float floating contaminants contained in the sewage so as to remove the floating contaminants;
filtering the sewage, from which floating contaminants are removed, by using at least one pressurized long-fiber filtering device, and discharging treated water;
backwashing the pressurized long-fiber filtering device and filtering discharged backwashing wastewater by using at least one submerged-type long-fiber filtering device and returning the backwashing wastewater to the flowrate balancing tank; and
concentrating and collecting backwashing wastewater discharged by backwashing the submerged-type long-fiber filtering device, in a submerged-type filter tank accommodating the submerged-type long-fiber filtering device so as to dehydrate and discharge the backwashing wastewater by using a sludge dehydrator.

11. The sewage treatment method of claim 10, wherein the backwashing of the pressurized long-fiber filtering device or the submerged-type long-fiber filtering device comprises supplying backwashing water by using the pressurized long-fiber filtering device or the submerged-type long-fiber filtering device for at least 20 seconds to 300 seconds, to float the long-fiber filter medium of the submerged-type long-fiber filtering device, injecting only backwashing air for at least 10 seconds to 300 seconds, simultaneously injecting backwashing water and backwashing air for at least 10 seconds to 300 seconds, injecting only backwashing air again for at least 20 seconds to 360 seconds, injecting backwashing water and backwashing air again for at least 20 seconds to 360 seconds, and then injecting a functional chemical softening the long fiber of the long-fiber filter medium with backwashing water to backwash the pressurized long-fiber filtering device or the submerged-type long-fiber filtering device.
